(19) United States
(12) Patent Application Publication
(10) Pub. No.: US 2026/0333503 A1
(43) Pub. Date: Oct. 22, 2026

(54) ACCESS STRATUM (AS) CONTEXT FOR RADIO RESOURCE CONTROL (RRC) INACTIVE STATE

(71) Applicant: Lenovo (United States) Inc., Morrisville, NC (US)

(72) Inventors: Prateek Basu Mallick, Dreieich (DE); Thomas Ralph Luetzenkirchen, Berlin (DE); Joachim Löhr, Wiesbaden (DE); Genadi Velev, Darmstadt (DE)

(73) Assignee: Lenovo (United States) Inc., Morrisville, NC (US)

(21) Appl. No.: 19/342,287

(22) Filed: Sep. 26, 2025

(51) Int. Cl. H04W 76/27; H04W 60/06; H04W 64/00

(52) U.S. Cl. CPC H04W 76/27; H04W 60/06; H04W 64/00

(57) ABSTRACT

Various aspects of the present disclosure relate to access stratum (AS) context for radio resource control (RRC) inactive state. A network equipment (NE), receives, from a first radio access network (RAN) node, an indication that a user equipment (UE) transitions to a radio resource control (RRC) inactive state. The NE receives, from a core network (CN) entity, an indication of a CN area update for the UE, the indication of the CN area update based on a change in UE location and including at least one identifier for the CN entity. The NE transmits access stratum (AS) context information for the UE to a second RAN node associated with the CN, the AS context information including small data transmission (SDT) configuration including a data radio bearer (DRB) list permitted to transmit data in the RRC inactive state and a medium access control (MAC) physical (PHY) configured grant (CG) configuration.

### TECHNICAL FIELD

The present disclosure relates to wireless communications, and more specifically to connectivity states in wireless communications.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to receive a radio resource control (RRC) inactive configuration from a first radio access network (RAN) node; transmit, to a second RAN node, a resume request including one or more of a UE identifier, a core network (CN) element identifier, or a RAN node identifier; and receive, based at least in part on the resume request, a resume accept indication from the second RAN node.

A processor (e.g., a standalone processor chipset, or a component of a UE) for wireless communication is described. The processor may be configured to, capable of, or operable to perform one or more operations as described herein. For example, the processor may be configured to, capable of, or operable to receive a RRC inactive configuration from a first RAN node; transmit, to a second RAN node, a resume request including one or more of a UE identifier, a CN element identifier, or a RAN node identifier; and receive, based at least in part on the resume request, a resume accept indication from the second RAN node.

A method performed or performable by a UE for wireless communication is described. The method may include receiving a RRC inactive configuration from a first RAN node; transmitting, to a second RAN node, a resume request including one or more of a UE identifier, a CN element identifier, or a RAN node identifier; and receiving, based at least in part on the resume request, a resume accept indication from the second RAN node.

In some implementations of the UE, the processor, and the method described herein, the resume request is performed as part of a single area update procedure.

An NE (e.g., a base station) for wireless communication is described. The NE may be configured to, capable of, or operable to perform one or more operations as described herein. For example, the NE may be configured to, capable of, or operable to receive, from a first RAN node, an indication that a UE transitions to a RRC inactive state; receive, from a CN entity, an indication of a CN area update for the UE, the indication of the CN area update based at least in part on a change in UE location and including at least one identifier for the CN entity; and transmit access stratum (AS) context information for the UE to a second RAN node associated with the CN, the AS context information including small data transmission (SDT) configuration including a data radio bearer (DRB) list permitted to transmit data in the RRC inactive state and a medium access control (MAC) physical (PHY) configured grant (CG) configuration.

A processor (e.g., a standalone processor chipset, or a component of a NE) for wireless communication is described. The processor may be configured to, capable of, or operable to perform one or more operations as described herein. For example, the processor may be configured to, capable of, or operable to receive, from a first RAN node, an indication that a UE transitions to a RRC inactive state; receive, from a CN entity, an indication of a CN area update for the UE, the indication of the CN area update based at least in part on a change in UE location and including at least one identifier for the CN entity; and transmit AS context information for the UE to a second RAN node associated with the CN, the AS context information including SDT configuration including a DRB list permitted to transmit data in the RRC inactive state and a MAC PHY CG configuration.

A method performed or performable by an NE (e.g., a base station) for wireless communication is described. The method may include receiving, from a first RAN node, an indication that a UE transitions to a RRC inactive state; receiving, from a CN entity, an indication of a CN area update for the UE, the indication of the CN area update based at least in part on a change in UE location and including at least one identifier for the CN entity; and transmitting AS context information for the UE to a second RAN node associated with the CN, the AS context information including SDT configuration including a DRB list permitted to transmit data in the RRC inactive state and a MAC PHY CG configuration.

In some implementations of the NE, the processor, and the method described herein, the NE, the processor, and the method may further be configured to, capable of, operable to, performed to, or performable to one or more of: store one or more internet protocol (IP) addresses of one or more CN elements of the CN; store one or more IP addresses of one or more RAN nodes associated with the CN; store a mapping of the one or more IP addresses of the one or more CN elements to one or more other identities of the one or more CN elements; or store a mapping of the one or more IP addresses of the one or more RAN nodes to one or more other identities of the one or more RAN nodes.

In some implementations of the NE, the processor, and the method described herein, the NE, the processor, and the method may further be configured to, capable of, operable to, performed to, or performable to maintain a mapping between a UE identifier of the UE and an associated RAN context.

In some implementations of the NE, the processor, and the method described herein, the NE, the processor, and the method may further be configured to, capable of, operable to, performed to, or performable to update the mapping based at least in part on a CN allocation, a CN update, or a CN change.

In some implementations of the NE, the processor, and the method described herein, the NE, the processor, and the method may further be configured to, capable of, operable to, performed to, or performable to register with a network function (NF) as a trusted service for one or more CN functions of the CN.

In some implementations of the NE, the processor, and the method described herein, the NE, the processor, and the method may further be configured to, capable of, operable to, performed to, or performable to receive an indication of an RRC release of the UE or a transition of the UE to an idle mode; and store association data for an association between a UE identifier of the UE and the first RAN node.

In some implementations of the NE, the processor, and the method described herein, the NE, the processor, and the method may further be configured to, capable of, operable to, performed to, or performable to receive an indication of deregistration of the UE from the RAN; and delete a mapping of a UE identity of the UE to the RAN.

In some implementations of the NE, the processor, and the method described herein, the NE, the processor, and the method may further be configured to, capable of, operable to, performed to, or performable to receive a query including a CN element identifier; and transmit, based at least in part on the query, a response including an address for the CN element.

In some implementations of the NE, the processor, and the method described herein, the NE, the processor, and the method may further be configured to, capable of, operable to, performed to, or performable to receive a query including a RAN node identifier; and transmit, based at least in part on the query, a response including an address for the RAN node.

In some implementations of the NE, the processor, and the method described herein, the NE, the processor, and the method may further be configured to, capable of, operable to, performed to, or performable to receive a query including an identifier for the UE; and transmit, based at least in part on the query, a response including a UE identity for the UE.

In some implementations of the NE, the processor, and the method described herein, the UE identity is determined based at least in part on a mapping of the UE identifier to the RAN node.

In some implementations of the NE, the processor, and the method described herein, the NE is implemented as part of a network repository function (NRF).

An NE (e.g., a base station) for wireless communication is described. The NE may be configured to, capable of, or operable to perform one or more operations as described herein. For example, the NE may be configured to, capable of, or operable to transmit, to a UE and based at least in part on a RRC connection release for a UE, an RRC inactive configuration; and transmit, to a serving access and mobility management function (AMF) of the UE, the RRC inactive configuration.

A processor (e.g., a standalone processor chipset, or a component of a NE) for wireless communication is described. The processor may be configured to, capable of, or operable to perform one or more operations as described herein. For example, the processor may be configured to, capable of, or operable to transmit, to a UE and based at least in part on a RRC connection release for a UE, an RRC inactive configuration; and transmit, to a serving AMF of the UE, the RRC inactive configuration.

A method performed or performable by an NE (e.g., a base station) for wireless communication is described. The method may include transmitting, to a UE and based at least in part on a RRC connection release for a UE, an RRC inactive configuration; and transmitting, to a serving AMF of the UE, the RRC inactive configuration.

In some implementations of the NE, the processor, and the method described herein, the RRC inactive configuration includes one or more of: AS context including a suspend configuration; or SDT configuration including DRB list permitted to transmit data in an RRC inactive state and a MAC PHY CG configuration.

An NE (e.g., a base station) for wireless communication is described. The NE may be configured to, capable of, or operable to perform one or more operations as described herein. For example, the NE may be configured to, capable of, or operable to receive a RRC resume request for a UE including a UE identifier and a CN identifier; transmit, to a CN function of the CN, a request for AS context information for the UE, the request including the UE identifier; receive, based at least in part on the request, an address of an AMF associated with the UE; and transmit, to the AMF, a request for AS information associated with the UE.

A processor (e.g., a standalone processor chipset, or a component of a NE) for wireless communication is described. The processor may be configured to, capable of, or operable to perform one or more operations as described herein. For example, the processor may be configured to, capable of, or operable to receive a RRC resume request for a UE including a UE identifier and a CN identifier; transmit, to a CN function of the CN, a request for AS context information for the UE, the request including the UE identifier; receive, based at least in part on the request, an address of an AMF associated with the UE; and transmit, to the AMF, a request for AS information associated with the UE.

A method performed or performable by an NE (e.g., a base station) for wireless communication is described. The method may include receiving a RRC resume request for a UE including a UE identifier and a CN identifier; transmitting, to a CN function of the CN, a request for AS context information for the UE, the request including the UE identifier; receiving, based at least in part on the request, an address of an AMF associated with the UE; and transmitting, to the AMF, a request for AS information associated with the UE.

In some implementations of the NE, the processor, and the method described herein, the NE, the processor, and the method may further be configured to, capable of, operable to, performed to, or performable to receive the AS context information associated with the UE; and security information including one or more of an AS key, a nonce, or a counter value.

In some implementations of the NE, the processor, and the method described herein, the security information is configured to be used to derive AS or non-AS (NAS) keys.

In some implementations of the NE, the processor, and the method described herein, the NE, the processor, and the method may further be configured to, capable of, operable to, performed to, or performable to transmit a resume accept indication indicating that the RRC resume request of the UE is allowed.

### BRIEF DESCRIPTION OF THE DRAWINGS

FIG. 1 illustrates an example of a wireless communications system in accordance with aspects of the present disclosure.

FIG. 2 illustrates an example signaling diagram in accordance with aspects of the present disclosure.

FIGS. 3 and 4 illustrate an example information element.

FIG. 5 illustrates a system in accordance with aspects of the present disclosure.

FIGS. 6 through 9 illustrate examples of signaling diagrams in accordance with aspects of the present disclosure.

FIG. 10 illustrates an example of a UE in accordance with aspects of the present disclosure.

FIG. 11 illustrates an example of a processor in accordance with aspects of the present disclosure.

FIG. 12 illustrates an example of an NE in accordance with aspects of the present disclosure.

FIGS. 13 through 16 illustrate flowcharts of methods in accordance with aspects of the present disclosure.

### DETAILED DESCRIPTION

In a wireless communications system, a UE and an NE (e.g., a base station, gNB) may support wireless communication (e.g., reception and/or transmission of wireless communication) using time-frequency resources. RRC is a control plane protocol in wireless communication systems that manages a connection between the UE and the NE. RRC defines three states: RRC idle (RRC_IDLE), RRC inactive (RRC_INACTIVE), and RRC connected (RRC_CONNECTED). In the RRC idle state, the UE is disconnected from (e.g., not actively connected to) the NE but may continue to monitor for paging and broadcast messages. In the RRC inactive state, the UE may maintain network context with reduced signaling and power consumption. The In RRC connected, the UE has is connected to the NE and may transmit and/or receive control information and/or data. A drawback of the RRC inactive state is that it might only be applicable within a smaller coverage area (e.g., RAN area) of the NE compared with a larger coverage area. Additionally, in the RRC inactive state, visibility of an anchor NE that stores UE AS context may be limited, as retrieving UE context over an X2 interface between NE (e.g., RAN nodes) may not scale effectively to wider areas due to operational and deployment challenges.

Aspects of the present disclosure are described in the context of a wireless communications system and include implementations that provides broader coverage (e.g., applicability) area for an RRC inactive state. For example, in some implementations, UE AS context may be maintained in a CN, and an NF may enable an NE (e.g., a RAN node) to retrieve the UE AS context even if the NE is geographically (e.g., physically) distant from an anchor NE that created or last updated the UE AS context. In some implementations, the described NF may maintain addressing of the NEs and relevant CN nodes. In some implementations, the described NF may be implemented as an NRF or as a function interacting directly with the NRF on behalf of the NE. By maintaining and communicating UE AS context between different CN nodes, a UE may move between different geographical regions while in an RRC inactive state and may resume RRC connectivity according to a previous UE AS context. By performing the described techniques, a UE in a wireless communications system can reduce power consumption (e.g., by staying in RRC inactive state during mobility) and may achieve greater state reliability in mobility scenarios.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

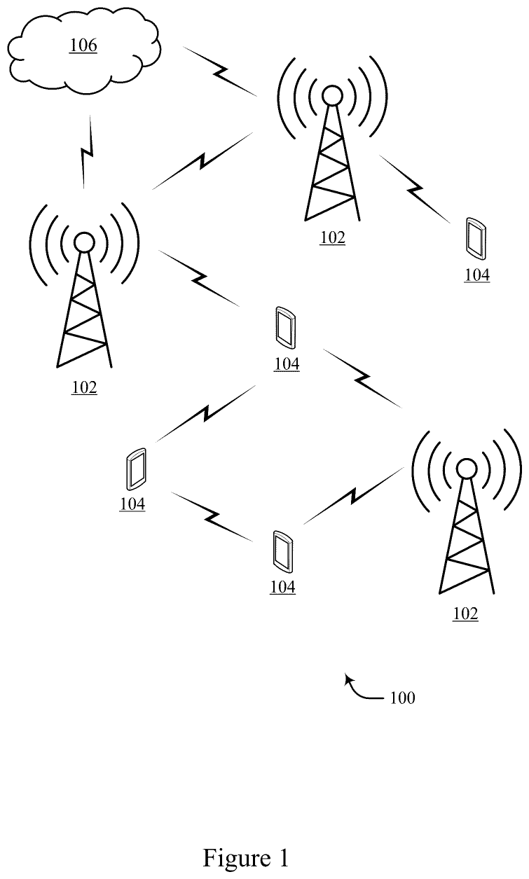

FIG. 1 illustrates an example of a wireless communications system 100 in accordance with aspects of the present disclosure. The wireless communications system 100 may include one or more NEs 102, one or more UEs 104, and a CN 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a NF, a network entity, a RAN, a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more NFs of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 receives a RRC inactive configuration from a first RAN node and transmits, to a second RAN node, a resume request including one or more of a UE identifier, a CN element identifier, or a RAN node identifier. The UE 104 receives, based at least in part on the resume request, a resume accept indication from the second RAN node.

An NE 102 (e.g., a base station, gNB) receives, from a first RAN node, an indication that a UE transitions to a RRC inactive state. The NE 102 receives, from a CN entity, an indication of a CN area update for the UE, the indication of the CN area update based at least in part on a change in UE location and including at least one identifier for the CN entity. The NE 102 transmits AS context information for the UE to a second RAN node associated with the CN, the AS context information including SDT configuration including a DRB list permitted to transmit data in the RRC inactive state and a MAC PHY CG configuration.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

In some wireless communications systems, RRC states include RRC_IDLE, RRC_INACTIVE, and RRC_CONNECTED. RRC_IDLE can be implemented for public land mobile network (PLMN) selection, system information broadcast, cell re-selection mobility, paging for mobile terminated data initiated by 5GC, transfer of multicast broadcast services (MBS) broadcast data to a UE over multicast radio bearers (MRBs), and discontinuous reception (DRX) for CN paging configured by NAS. RRC_INACTIVE can be implemented for PLMN selection, system information broadcast, cell re-selection mobility, paging initiated by NG-RAN (RAN paging), RAN-based notification area (RNA) managed by NG-RAN, DRX for RAN paging configured by NG-RAN, 5GC-NG-RAN connection (both C/U-planes) established for UE, UE inactive AS context stored in NG-RAN and the UE, NG-RAN knowledge of the RNA which the UE belongs, transfer of MBS multicast/broadcast data to the UE over MRB(s), and transfer of unicast data and/or signaling to/from the UE over radio bearers configured for SDT. RRC_CONNECTED can be implemented for 5GC-NG-RAN connection (both C/U-planes) for UE, UE AS context is stored in NG-RAN and the UE, NG-RAN knowledge of the cell which the UE belongs, transfer of unicast data to/from the UE, transfer of MBS multicast/broadcast data to the UE over MRB(s), and network controlled mobility including measurements.

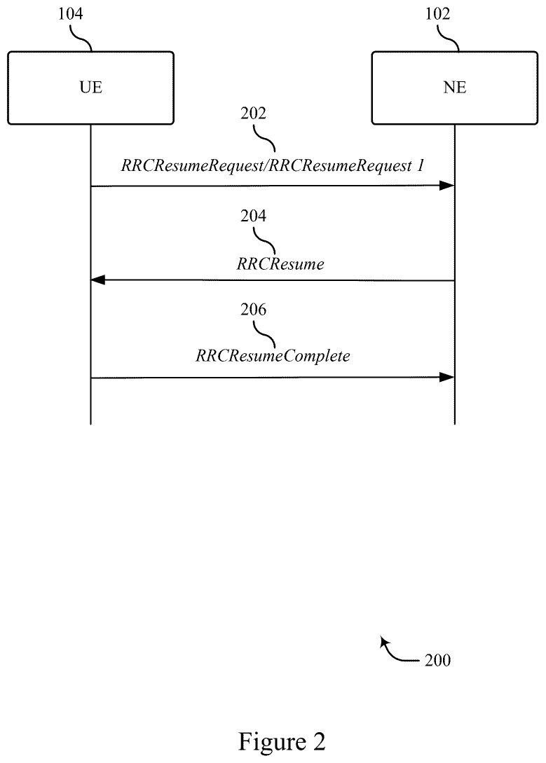

FIG. 2 illustrates an example signaling diagram 200 in accordance with aspects of the present disclosure. In some examples, the signaling diagram 200 implements or is implemented by aspects of the wireless communications system 100. The signaling diagram 200 may implement or be implemented by one or more devices, such as an NE 102 and a UE 104, which may be examples of an NE 102 and a UE 104 as described with reference to FIG. 1. The signaling diagram 200 may illustrate an example of an RRC connection resume successful procedure between the NE 102 and the UE 104. Alternative examples of the following may be implemented, where some processes are performed in a different order than described or are not performed. In some cases, processes may include additional features not mentioned below, or further processes may be added.

In the example of FIG. 2, the RRC connection resume successful procedure may include the UE 104 transmitting an RRC resume request 202 to the NE 102. In response to, or based at least in part on, receiving the RRC resume request 202, the NE 102 may transmit an RRC resume response 204 to the UE 104. The UE 104 may transmit an RRC resume complete message 206 to the NE 102 in response to, or based at least in part on, receiving the RRC resume response 204.

Additionally, or alternatively, one or more of the NE 102 and the UE 104 may support an RRC inactive procedure to resume a suspended RRC connection (e.g., including resuming SRB(s), DRB(s) and multicast MRB(s)) or perform an RNA update. The RRC inactive procedure may be used to initiate SDT in RRC_INACTIVE. SDT is a feature whereby limited amount of data can be transferred between the UE 104 and the NE 102, for example, without requiring the UE 104 to transition to an RRC connected state.

In some examples, the UE 104 may initiate an RRC inactive procedure when upper protocol layers (e.g., RRC, MAC) or AS requests a resume of a suspended RRC connection or for initiating SDT (e.g., when responding to RAN paging, upon triggering RNA updates while the UE 104 is in RRC_INACTIVE, for requesting configuration for SRS for positioning, for activation of preconfigured positioning SRS in RRC_INACTIVE, upon receiving RRCRelease message including resumeIndication).

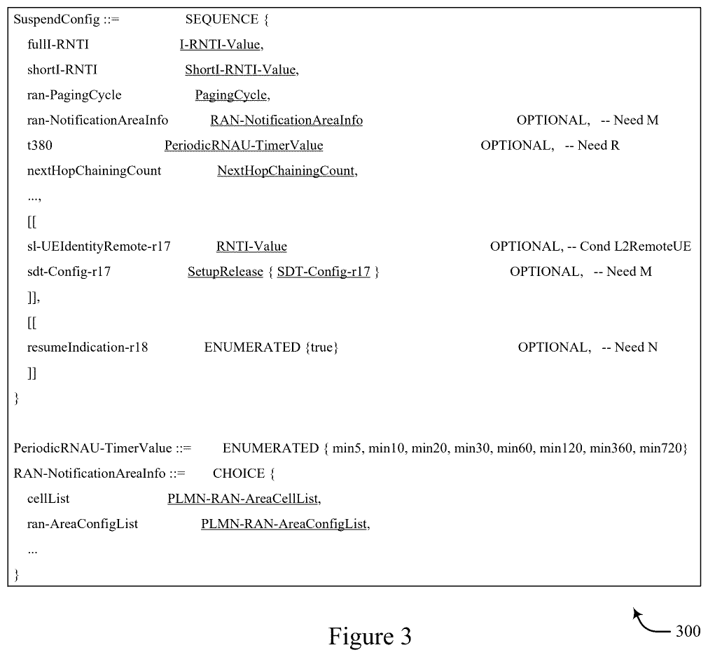

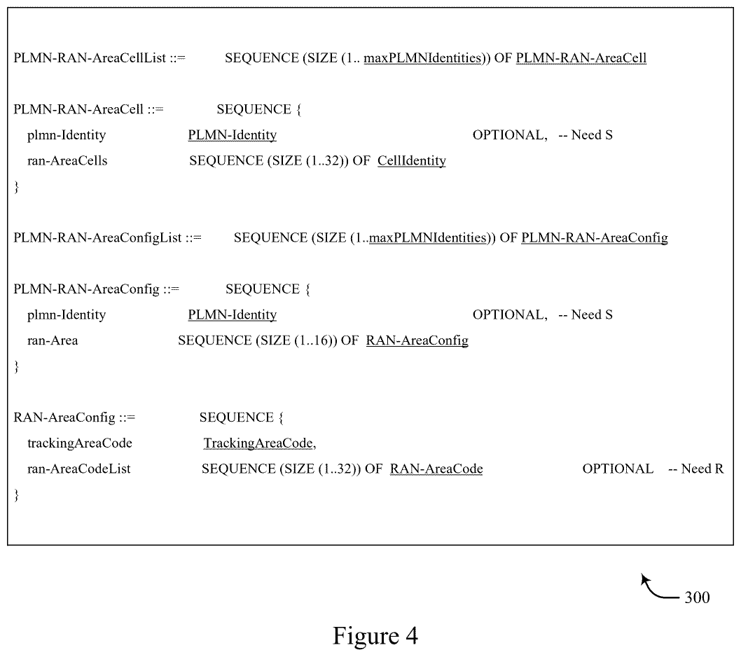

FIGS. 3 and 4 illustrate an example information element 300. The information element 300, for example, may be used when an RRC connected UE is sent to RRC inactive state by a current serving cell, which includes a Suspend Config in the RRC Release message. The Suspend config may include information on UE identity to be used in RRC inactive state, information on RNA, NCC, etc., such as illustrated in the information element 300.

In implementations, an RRC State machine is described that may reduce state transitions (e.g., by reducing the need to transition to RRC Connected by extending RRC inactive state) and save UE battery by minimizing transitions to RRC Connected. Implementations, for example, may reduce a number of RRC states and/or by reducing the scope of RRC Idle and extending the RRC inactive states. Regarding reducing the number of RRC states, while RRC Connected state supports service delivery to the UE, it incurs higher UE battery consumption due to measurement reporting from the UE. RRC Idle may reduce UE battery consumption but no data transfer may be possible in this state. RRC inactive state may enable features of both the RRC Connected and RRC Idle States. RRC inactive, for example, may reduce UE battery consumption such as in RRC Idle state and may enable limited data transfer possibility using a SDT feature in both UL and DL. However, mobility beyond a cell where a UE entered RRC inactive state may reduce data transfer options.

Implementations may thus include augmentations to the RRC inactive state. For example, in a UE power on scenario, the UE may start with a NULL state and search for cells belonging to the NAS provided frequency-RAT pair. When such a cell is located, the UE may initiate a combined NAS-AS registration procedure. Until the completion of registration, the UE may remain in the NULL state where the UE may receive broadcast messages and initiate an NAS procedure of registration, respond to authentication, and security related transactions from the network. In implementations, paging and broadcast can be received in RRC inactive state using the search space and CORESET defined for that purpose and signaled using system information broadcast. Implementations also include AS and NAS combined updates. In implementations, extending RRC inactive can facilitate data connectivity in wider areas without requiring transition to RRC Connected. Extending RRC inactive can enable a UE to transition to the RRC Connected state in a bigger geographical area, e.g., beyond RNA. Implementations thus may enable the RRC inactive state to be extended beyond a current RNA.

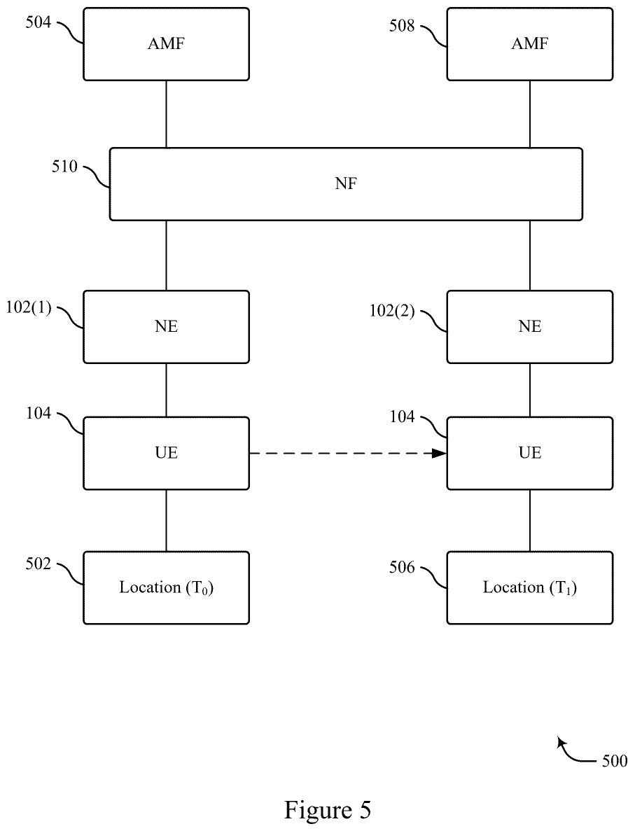

FIG. 5 illustrates a system 500 in accordance with aspects of the present disclosure. In the system 500, at a time T₀ a UE 104 is connected to an NE 102(1) at a location 502 that is associated with an AMF 504. At a time T₁ the UE 104 then moves from the location 502 to a location 506 (e.g., a different geographical location) and connects to an NE 102(2) associated with an AMF 508. In implementations, the UE 104 transitions to an RRC inactive state when connected to the NE 102(1) and then attempts to resume an RRC connected state when moving to the location 506. The UE 104, for example, may attempt to resume RRC connected state based on mobile originated action (e.g., originating a mobile call and/or originating data transmission) and/or based on mobile terminated action (e.g., based on receiving a paging message).

In implementations, a NF 510 (e.g., as part of an NE 102) may facilitate (e.g., manage) RRC connection resumption which includes how the network maintains and retrieves (e.g., fetches, obtains, determines) AS context of the UE 104. In implementations, the NF 510 may perform various functionality and/or actions. For example, the NF 510 may perform operations for UE identity management, such as: Storing IP addresses of one or more CN elements; storing IP addresses of one or more radio network nodes; maintaining an address-list mapping stored IP address of each CN element with another identity of this element. In implementations, an identity of a CN element may include: PLMN Identity; AMF identifier; and/or globally unique AMF ID (GUAMI). A GUAMI identifies a specific AMF serving a UE and may include: mobile country code (MCC); mobile network code (MNC); AMF region ID (identifies the AMF region); AMF set ID (identifies an AMF set within the region); AMF pointer (identifies a specific AMF within an AMF set). An identifier of a CN element may also include an xTunnel identifier over a reference point (e.g., N4 for UPF).

Identity management by the NF 510 may further include maintaining an address-list mapping stored IP address of each of the radio network nodes with another identity the radio network node. In one example, one or more of the following identities may be used: Cell identity (e.g., physical cell identity or global cell identity (e.g. including PLMN identity, tracking area code and a 36-bit long cell identity); and/or gNB or similar radio network identity.

In implementations, the NF 510 may perform operations for subscription permanent identifier (SUPI)-to-RAN context mapping mechanism such as where the NF 510 may maintain a mapping between UE identifiers (e.g., SUPI, globally unique temporary identifier (GUTI), temporary mobile subscriber identity (TMSI)) and an associated RAN context. This mapping may be established and updated by the AMF, which may communicate updates to the NF 510 including: SUPI, GUTI, and/or S-TMSI; associated next generation application protocol (NGAP) UE ID; and/or serving gNB identifier. Updates may occur when a UE CN identity is allocated, updated, or changed (e.g., during registration, AMF handover, or RRC resume).

In implementations, the NF 510 may perform operations for managing privacy and trust boundaries. For example, the NF 510 may register with the NRF as a trusted SBA service and allow other CN functions to discover and interact with it securely, e.g., using OAuth2-based authorization token. RAN nodes may discover the NF 510, such as via: RAN pre-configuration with the NRF IP address or fully qualified domain name (FQDN) during deployment; domain name server (DNS) resolution using a domain name (e.g., nnf. operator-domain. com); bootstrap via AMF: an AMF may provide the NRF address during registration of handover via the N2 interface. In implementations, an NRF may enforce access control policies based on the identity and role of a requesting entity. In implementations, CN functions may be granted access to sensitive operations (e.g., SUPI-based queries). In implementations, RAN nodes may be restricted to non-sensitive operations (e.g., querying CN IPs using GUAMI).

In implementations, the NF 510 may perform operations for handling of UE state transitions. For example, upon RRC release or transition to idle mode, the NF 510 may store a most recent association between a UE identifier (e.g., SUPI, GUTI, S-TMSI) and the RAN node where the UE was most recently connected. Upon UE deregistration, the NF 510 may delete a UE identifier to RAN mapping.

In implementations, the NF 510 may perform operations for providing services to RAN nodes. For example, a RAN node may query with an AMF identifier (or another CN element identifier) requesting an IP Address or another identifier to access the included CN element. Upon receiving the request, the NF 510 may refer to the address-list and include the IP address (or other identifier) of the queried CN element in its response to the RAN node.

In implementations, the NF 510 may perform operations for providing services to CN nodes. For example, a CN node may query with an NE 102 identifier requesting an IP address or other identifier to access the included RAN node. A static mapping within the NF 510 can be used and/or a mechanism where RAN nodes register their identifiers with the NF 510. Upon receiving a request, the NF 510 can refer to the address-list and include the IP address and/or other address of the queried RAN node in its response to the NE 102.

In implementations for providing service to CN nodes, a CN node may query the NF 510 with a UE identifier (e.g., GUTI, SUPI, S-TMSI, RAN identifier of the UE such as C-RNTI or I-RNTI, etc.) requesting an IP Address and/or other identifier to access the RAN node where an AS of a UE is located or stored. The UE identity may be sent to NF 510 each time a new UE identity is allocated (e.g., when the UE enters RRC connected state), changed (e.g., as a result of handover), or when the UE RRC connection is being released. Upon receiving the query, the NF 510 may refer to the address list and include the IP address or other identifier of the queried RAN node in its response to the CN. The address list may include the mapping of the UE identifier and the RAN node where the most recent known AS of the UE is located or stored.

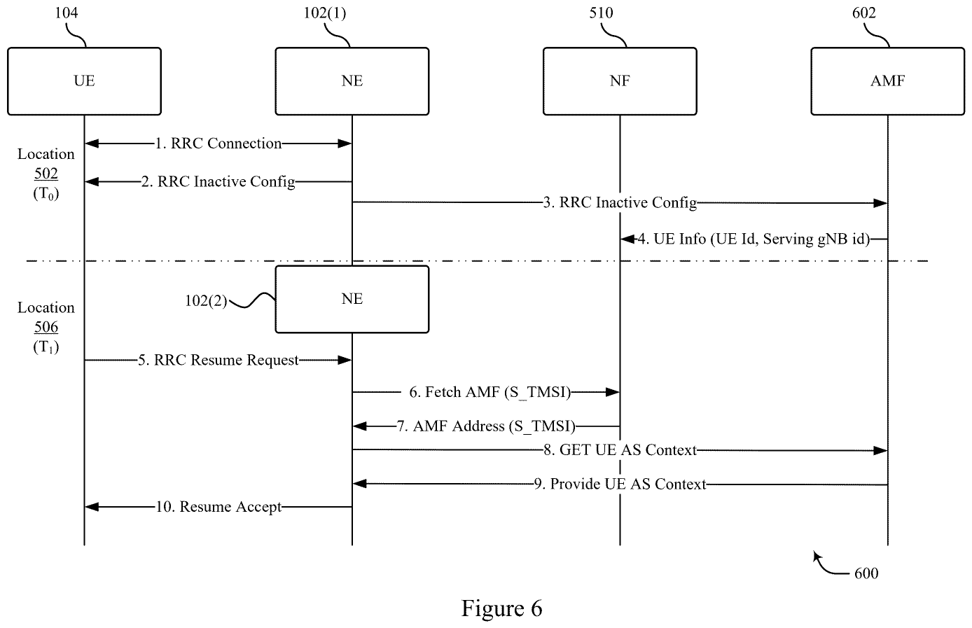

FIG. 6 illustrates an example signaling diagram 600 in accordance with aspects of the present disclosure. At step (1), the UE 104 establishes an RRC connection with the NE 102(1) at the location 502. The RRC connection may be used for registration after UE power on or for availing wireless network services such as voice call or data services. At step (2), the RRC connection is released and the NE 102(1) includes RRC inactive configuration (e.g., AS context including configuration including suspend configuration, SDT configuration including a DRB list permitted to transmit data in RRC inactive state and the MAC-PHY-CG configuration) in a release message to the UE 104. This information may also be included prior to the connection release in an RRC based reconfiguration message. RRC release may activate the use of the RRC inactive configuration.

At step (3) the NE 102 (1) provides the RRC inactive configuration to the serving AMF 602 of the UE 104. The UE AS context may be stored in a CN element along with the UE NAS Context. At step (4) the AMF updates the NF 510 with UE info (e.g., SUPI, GUTI, or S-TMSI) and associated NGAP UE ID and serving NE identifier. At step (5) the UE 104 moves to the location 506 and resumes RRC connection by sending a resume request to the NE 102(2) including one or more of a UE identifier, a CN element identifier, and/or a RAN node identifier.

At step (6) if the NE 102(2) has a stored context for the received UE identifier, or if the NE 102(2) can directly access the included RAN node identifier, the NE 102(2) retrieves the UE AS context and may allow the UE 104 to resume RRC connection. Alternatively, or in addition, the NE 102(2) can send a request to the NF 510 including a received CN identifier (e.g., an AMF identifier) and/or a UE identifier (e.g., a UE identifier received from the UE 104, e.g., SUPI, GUTI, or S-TMSI).

At step (7), the NF 510 may look up the address list for the received CN element identifier and send a response to the NE 102(2) including an IP address (or other identifier) for the queried CN element. At step (8) and using the received IP address/identifier, the NE 102(2) makes an HTTP request (e.g., GET) to the AMF 602 requesting UE AS context for the UE 104. At step (9) the AMF 602 provides the UE AS Context to the NE 102(2) along with security material AS key, NONCE, or a counter value that may be used by the UE 104 to derive AS or NAS security keys. At step (10) the NE 102(2) may permit the UE 104 to resume the RRC connection and send a resume accept. If the UE context was not able to be retrieved, the NE 102(2) may send a RRC connection setup procedure to bring the UE 104 for an RRC connected state. In implementations, the NF 510 may be implemented as a separate network entity from the AMF 602 or may be integrated (e.g., co-located) with the AMF 602.

In implementations, the NF 510 may be implemented as a NRF or as a function interacting directly with NRF on behalf of an NE 102. In such implementations, the NE 102 may serve as a NF service consumer and contact the NRF (e.g., the NF 510) to discover services available in the network based on service name and target NF type (e.g., of the AMF).

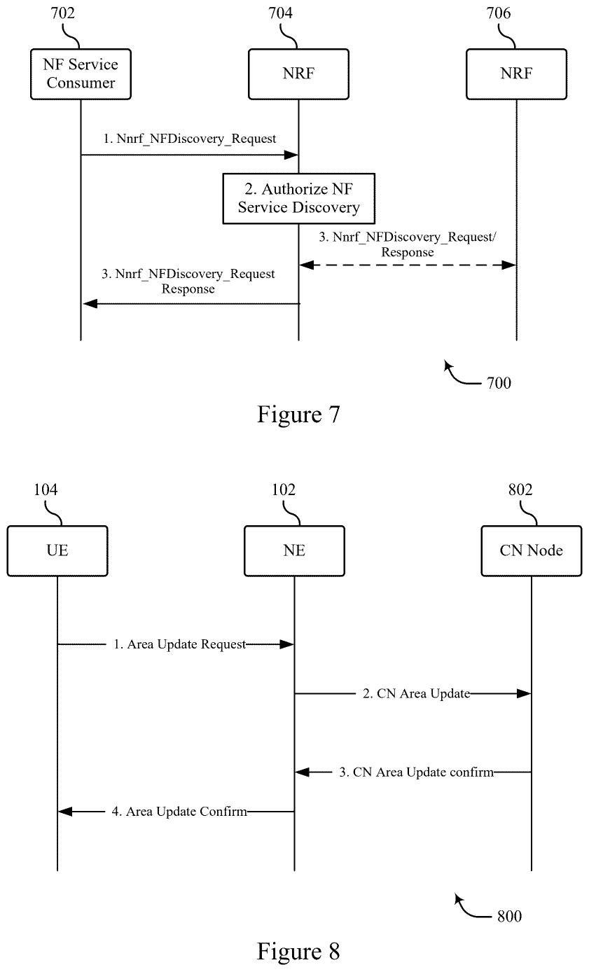

FIG. 7 illustrates an example signaling diagram 700 in accordance with aspects of the present disclosure. The signaling diagram 700, for example, illustrates an example procedure for NF/NF service discovery by an NF service consumer 702 (e.g., an NE 102) in a same PLMN.

At step (1), the NF service consumer 702 (e.g., NE 102, RAN node, gNB) determines to discover services available in the network based on service name and target NF type. The NF service consumer 702 invokes Nnrf_NFDiscovery_Request (e.g., expected NF service name, NF type of the expected NF instance, NF type of the NF consumer) from a configured NRF 704 in the same PLMN. The parameter may optionally include producer NF set ID, NF service set ID, SUPI, data set identifier(s), external group ID (e.g., for unified data management (UDM), unified data repository (UDR) discovery), UE routing indicator and home network public key identifier (e.g., for UDM and authentication server function (AUSF) discovery), single network slice selection assistance information (S-NSSAI), network slice instance (NSI) ID if available, and other service-related parameters. In some implementations for AMF discovery, the parameters may include AMF region ID, AMF set ID, and/or tracking area identity (TAI). The NF service consumer 702 may indicate a preference for target NF location in the Nnrf_NFDiscovery_Request.

Example inputs of the Nnrf_NFDiscovery_Request include one or more target NF service name(s), NF type of the target NF, NF type of the NF service consumer. If the target NF is an AMF and the consumer NF is an NE 102, the request may include TAI(s) and it may also include AMF region, AMF set, GUAMI, and target TAI(s). At step (2), the NRF 704 authorizes the Nnrf_NFDiscovery_Request. Based on the profile of the expected NF/NF service and the type of the NF service consumer, the NRF 704 may determine whether the NF service consumer 702 is allowed to discover the expected NF instance(s). If the expected NF instance(s) or NF service instance(s) are deployed in a certain network slice, the NRF 704 may authorize the discovery request according to the discovery configuration of the network slice. For example, the expected NF instance(s) may only be discoverable by the NF in the same network slice.

At step (3), if allowed, the NRF 704 determines a set of NF instance(s) matching the Nnrf_NFDiscovery_Request and internal policies of the NRF and sends the NF profile(s) of the determined NF instances. For the scenario when NF instance(s) reside in a target PLMN, the NRF in HPLMN may further query a NRF 706 in the target PLMN. Each NF profile may include at least the output required parameters to the NF service consumer via Nnrf_NFDiscovery_Request Response message. Examples of output from this operation may include: A set of NF instance profiles; an indication that “indirect communication with delegated discovery with NF selection at target domain is requested”; an indication that “indirect communication without delegated discovery with NF selection at target domain is requested” together with a set of NF instance profiles; a validity period for the discovery result.

In implementations, the set of NF instance profiles may include, per NF Instance: NF type, NF instance ID, FQDN or IP address(es) of the NF instance and if applicable, a list of service instances where each service instance has a service name, and/or a NF service instance ID and optionally endpoint address(es). Endpoint address(es) may be a list of IP addresses or an FQDN for the NF service instance. If the target NF is AMF, the endpoint address may include a list of GUAMI(s). Optionally, an endpoint address may include list of GUAMI(s) which can serve as backup for failure/maintenance. Based on the received FQDN or IP address(es) of the NF instance of an AMF, an NE 102 (e.g., the NF service consumer 702) may request UE access stratum context/configuration. For this purpose, as indicated previously, a UE ID including a CN UE ID (e.g., GUTI or S-TMSI) in part or in full can be used. Alternatively, the UE context may be stored in the CN element (e.g., AMF) along with the UE AS identity, e.g., a C-RNTI or I-RNTI. In such implementations, the NE 102 may request UE AS context/configuration including the UE AS ID.

Implementations include AS-NAS combined area update procedures. For example, in implementations a UE may perform a single (e.g., only one) update procedure (e.g., either AS or NAS based area update procedure but not both. Which of the AS or NAS update procedures is to be performed can be specified or made configurable by the network and the configured update procedure (AS or NAS) can be indicated in the system information broadcast or can be left to the UE implementation. In scenarios of UE implementation, the network may be configured to receive and handle both AS and NAS based area updates. In scenarios where update procedures are configured by the network, the network may be configured to handle the specified or configured area update request from the UE.

FIG. 8 illustrates an example signaling diagram 800 in accordance with aspects of the present disclosure. The signaling diagram 800, for example, illustrates an example procedure for AS based common area update procedure. At step (1) a UE 104 initiates a procedure and communicates an area update request to an NE 102. Upon receiving an area update request from the UE 104, at step (2) the NE 102 informs a CN node 802 (e.g., using the NF 510 as defined above or directly to one of the AMFs in the NE 102 area, or to an AMF indicated by the UE 104) about the location area update procedure, including UE NAS identity received from the UE or obtained from NF 510. The CN node 802 may treat this as an NAS area update procedure and store the new location of the UE 104. The new location can be used for paging purposes. In implementations, the CN node 802 can provide a new NAS location area list to the UE 104 (e.g., a new list of tracking areas. This information may be included in a NAS message to the UE 104 or may be embedded in the AS signaling sent to the UE 104 (area update confirm) as a response to UE area update request. At step (3) the CN node 802 communicates a new area list to the concerned NE 102 in CN area update confirm message. At step (4) the NE 102 communicates an area update confirm message to the UE 104 which includes information from the area update confirm message from the CN node 802 and may include an updated suspend config, SDT config, RNA/cell list, etc.

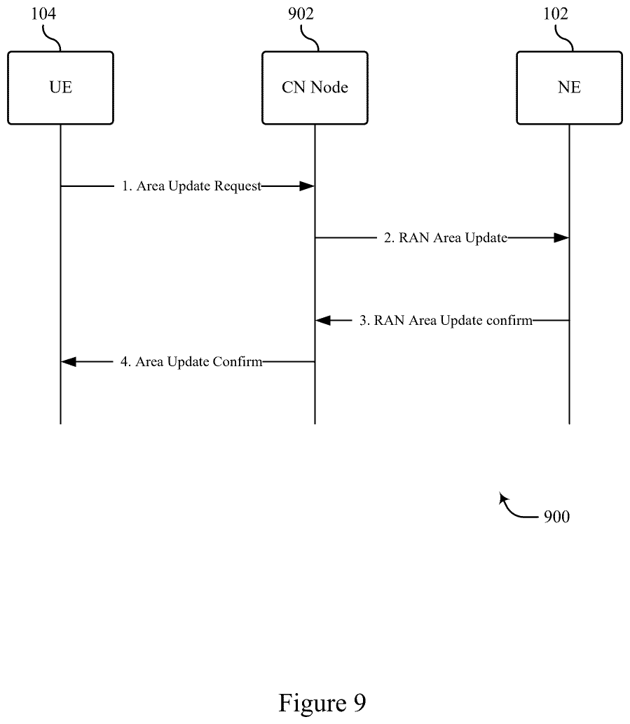

FIG. 9 illustrates an example signaling diagram 900 in accordance with aspects of the present disclosure. The signaling diagram 900, for example, illustrates a NAS based common area update procedure. At step (1), a UE 104 initiates a common procedure using NAS signaling and transmits an area update request to a CN node 902. Upon receiving NAS tracking area update request from the UE 104 included in the area update request message, at step (2) the CN node 902 informs an NE 102 (e.g., using NF 510, directly to an NE 102 from which the NAS message was received, or to an NE 102 indicated by the UE 104 in the request message) about the location area update procedure using a RAN area update message. The notification at step (2) may include a UE AS identity received from the UE 104 or obtained from NF 510. The NE 102 may process the update as an AS area update procedure and store the new location of the UE. The new location can be used for paging purposes. The NE 102 can provide a new RAN area list to the UE 104 (e.g., a new list of cells/RNAs). This information may be included in an AS message to the UE 104 (e.g., as an updated suspend config, SDT config, etc.) Alternatively, at step (3) the NE 102 provides this new area list to the initiating CN node 902 in a RAN area update confirm message. At step (4) the CN node 902 may communicate the same information via an area update confirm message to the UE 104 (or in a registration update message) along with an updated TS list.

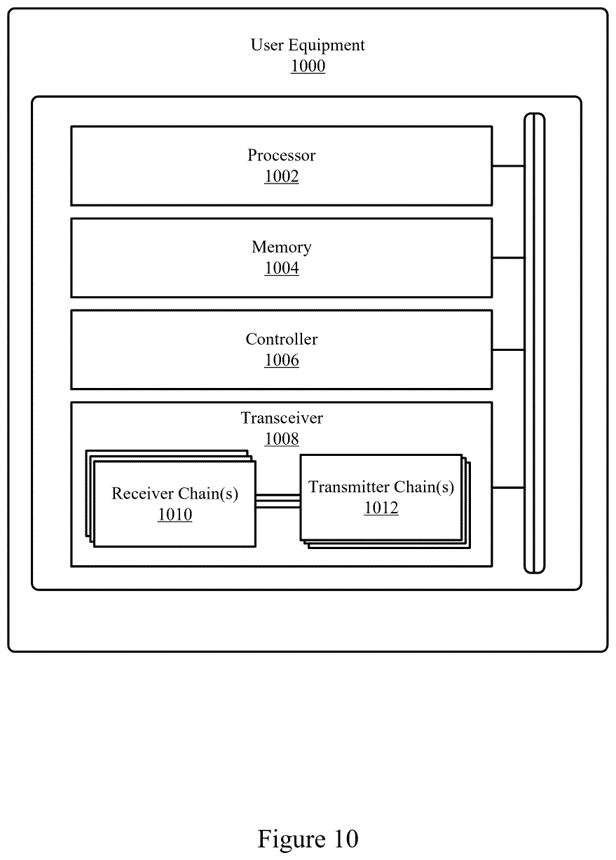

FIG. 10 illustrates an example of a UE 1000 in accordance with aspects of the present disclosure. The UE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the UE 1000 to perform various functions of the present disclosure.

The memory 1004 may include volatile or non-volatile memory. The memory 1004 may store computer-readable, computer-executable code including instructions when executed by the processor 1002 cause the UE 1000 to perform various functions described herein. The code may be stored in a non-transitory computer-readable medium such as the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the UE 1000 to perform one or more of the functions described herein (e.g., executing, by the processor 1002, instructions stored in the memory 1004). For example, the processor 1002 may support wireless communication at the UE 1000 in accordance with examples as disclosed herein. The UE 1000 may be configured to or operable to support a means for receiving an RRC inactive configuration from a first RAN node; transmitting, to a second RAN node, a resume request including one or more of a UE identifier, a CN element identifier, or a RAN node identifier; and receiving, based at least in part on the resume request, a resume accept indication from the second RAN node.

Additionally, the UE 1000 may be configured to support any one or combination of where the resume request is performed as part of a single area update procedure.

Additionally, or alternatively, the UE 1000 may support at least one memory (e.g., the memory 1004) and at least one processor (e.g., the processor 1002) coupled with the at least one memory and configured to cause the UE to receive a RRC inactive configuration from a first RAN node; transmit, to a second RAN node, a resume request including one or more of a UE identifier, a CN element identifier, or a RAN node identifier; and receive, based at least in part on the resume request, a resume accept indication from the second RAN node.

Additionally, the UE 1000 may be configured to support any one or combination of where the resume request is performed as part of a single area update procedure.

The controller 1006 may manage input and output signals for the UE 1000. The controller 1006 may also manage peripherals not integrated into the UE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the UE 1000 may include at least one transceiver 1008. In some other implementations, the UE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas to receive a signal over the air or wireless medium. The receiver chain 1010 may include at least one amplifier (e.g., a low-noise amplifier (LNA)) configured to amplify the received signal. The receiver chain 1010 may include at least one demodulator configured to demodulate the receive signal and obtain the transmitted data by reversing the modulation technique applied during transmission of the signal. The receiver chain 1010 may include at least one decoder for decoding the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

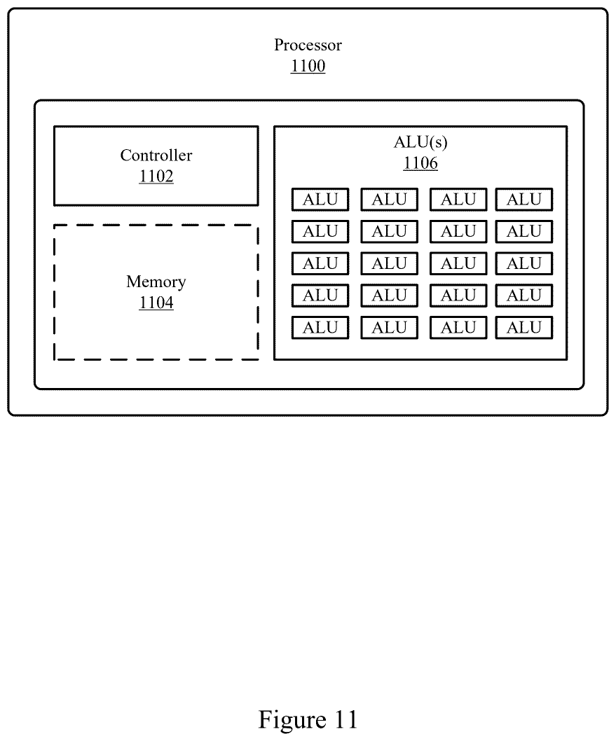

FIG. 11 illustrates an example of a processor 1100 in accordance with aspects of the present disclosure. The processor 1100 may be an example of a processor configured to perform various operations in accordance with examples as described herein. The processor 1100 may include a controller 1102 configured to perform various operations in accordance with examples as described herein. The processor 1100 may optionally include at least one memory 1104, which may be, for example, an L1/L2/L3 cache. Additionally, or alternatively, the processor 1100 may optionally include one or more arithmetic-logic units (ALUs) 1106. One or more of these components may be in electronic communication or otherwise coupled (e.g., operatively, communicatively, functionally, electronically, electrically) via one or more interfaces (e.g., buses).

The processor 1100 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1100) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1102 may be configured to manage and coordinate various operations (e.g., signaling, receiving, obtaining, retrieving, transmitting, outputting, forwarding, storing, determining, identifying, accessing, writing, reading) of the processor 1100 to cause the processor 1100 to support various operations in accordance with examples as described herein. For example, the controller 1102 may operate as a control unit of the processor 1100, generating control signals that manage the operation of various components of the processor 1100. These control signals include enabling or disabling functional units, selecting data paths, initiating memory access, and coordinating timing of operations.

The controller 1102 may be configured to fetch (e.g., obtain, retrieve, receive) instructions from the memory 1104 and determine subsequent instruction(s) to be executed to cause the processor 1100 to support various operations in accordance with examples as described herein. The controller 1102 may be configured to track memory addresses of instructions associated with the memory 1104. The controller 1102 may be configured to decode instructions to determine the operation to be performed and the operands involved. For example, the controller 1102 may be configured to interpret the instruction and determine control signals to be output to other components of the processor 1100 to cause the processor 1100 to support various operations in accordance with examples as described herein. Additionally, or alternatively, the controller 1102 may be configured to manage flow of data within the processor 1100. The controller 1102 may be configured to control transfer of data between registers, ALUs 1106, and other functional units of the processor 1100.

The memory 1104 may include one or more caches (e.g., memory local to or included in the processor 1100 or other memory, such as RAM, ROM, DRAM, SDRAM, SRAM, MRAM, flash memory, etc. In some implementations, the memory 1104 may reside within or on a processor chipset (e.g., local to the processor 1100). In some other implementations, the memory 1104 may reside externally to the processor chipset (e.g., remote to the processor 1100).

The memory 1104 may store computer-readable, computer-executable code including instructions that, when executed by the processor 1100, cause the processor 1100 to perform various functions described herein. The code may be stored in a non-transitory computer-readable medium such as system memory or another type of memory. The controller 1102 and/or the processor 1100 may be configured to execute computer-readable instructions stored in the memory 1104 to cause the processor 1100 to perform various functions. For example, the processor 1100 and/or the controller 1102 may be coupled with or to the memory 1104, the processor 1100, and the controller 1102, and may be configured to perform various functions described herein. In some examples, the processor 1100 may include multiple processors and the memory 1104 may include multiple memories. One or more of the multiple processors may be coupled with one or more of the multiple memories, which may, individually or collectively, be configured to perform various functions herein.

The one or more ALUs 1106 may be configured to support various operations in accordance with examples as described herein. In some implementations, the one or more ALUs 1106 may reside within or on a processor chipset (e.g., the processor 1100). In some other implementations, the one or more ALUs 1106 may reside external to the processor chipset (e.g., the processor 1100). One or more ALUs 1106 may perform one or more computations such as addition, subtraction, multiplication, and division on data. For example, one or more ALUs 1106 may receive input operands and an operation code, which determines an operation to be executed. One or more ALUs 1106 may be configured with a variety of logical and arithmetic circuits, including adders, subtractors, shifters, and logic gates, to process and manipulate the data according to the operation. Additionally, or alternatively, the one or more ALUs 1106 may support logical operations such as AND, OR, exclusive-OR (XOR), not-OR (NOR), and not-AND (NAND), enabling the one or more ALUs 1106 to handle conditional operations, comparisons, and bitwise operations.

The processor 1100 may support wireless communication in accordance with examples as disclosed herein. The processor 1100 may be configured to or operable to support at least one controller (e.g., the controller 1102) coupled with at least one memory (e.g., the memory 1104) and configured to cause the processor to receive a RRC inactive configuration from a first RAN node; transmit, to a second RAN node, a resume request including one or more of a UE identifier, a CN element identifier, or a RAN node identifier; and receive, based at least in part on the resume request, a resume accept indication from the second RAN node.

Additionally, the processor 1100 may be configured to or operable to support any one or combination of where the resume request is performed as part of a single area update procedure.

The processor 1100 may support wireless communication in accordance with examples as disclosed herein. The processor 1100 may be configured to or operable to support at least one controller (e.g., the controller 1102) coupled with at least one memory (e.g., the memory 1104) and configured to cause the processor to receive, from a first RAN node, an indication that a UE transitions to a RRC inactive state; receive, from a CN entity, an indication of a CN area update for the UE, the indication of the CN area update based at least in part on a change in UE location and including at least one identifier for the CN entity; and transmit AS context information for the UE to a second RAN node associated with the CN, the AS context information including SDT configuration including a DRB list permitted to transmit data in the RRC inactive state and a MAC PHY CG configuration.

Additionally, the processor 1100 may be configured to or operable to support any one or combination of where the at least one processor is operable to cause the NE to one or more of: store one or more internet protocol (IP) addresses of one or more CN elements of the CN; store one or more IP addresses of one or more RAN nodes associated with the CN; store a mapping of the one or more IP addresses of the one or more CN elements to one or more other identities of the one or more CN elements; or store a mapping of the one or more IP addresses of the one or more RAN nodes to one or more other identities of the one or more RAN nodes; the at least one processor is operable to cause the NE to: maintain a mapping between a UE identifier of the UE and an associated RAN context; the at least one processor is operable to cause the NE to: update the mapping based at least in part on a CN allocation, a CN update, or a CN change; the at least one processor is operable to cause the NE to: register with a NF as a trusted service for one or more CN functions of the CN; the at least one processor is operable to cause the NE to: receive an indication of an RRC release of the UE or a transition of the UE to an idle mode; and store association data for an association between a UE identifier of the UE and the first RAN node; the at least one processor is operable to cause the NE to: receive an indication of deregistration of the UE from the RAN; and delete a mapping of a UE identity of the UE to the RAN; the at least one processor is operable to cause the NE to: receive a query including a CN element identifier; and transmit, based at least in part on the query, a response including an address for the CN element; the at least one processor is operable to cause the NE to: receive a query including a RAN node identifier; and transmit, based at least in part on the query, a response including an address for the RAN node; the at least one processor is operable to cause the NE to: receive a query including an identifier for the UE; and transmit, based at least in part on the query, a response including a UE identity for the UE; the UE identity is determined based at least in part on a mapping of the UE identifier to the RAN node; the NE is implemented as part of a NRF.

The processor 1100 may support wireless communication in accordance with examples as disclosed herein. The processor 1100 may be configured to or operable to support at least one controller (e.g., the controller 1102) coupled with at least one memory (e.g., the memory 1104) and configured to cause the processor to transmit, to a UE and based at least in part on a RRC connection release for a UE, an RRC inactive configuration; and transmit, to a serving AMF of the UE, the RRC inactive configuration.

Additionally, the processor 1100 may be configured to or operable to support any one or combination of where the RRC inactive configuration includes one or more of: AS context including a suspend configuration; or SDT configuration including DRB list permitted to transmit data in an RRC inactive state and a MAC PHY CG configuration.

The processor 1100 may support wireless communication in accordance with examples as disclosed herein. The processor 1100 may be configured to or operable to support at least one controller (e.g., the controller 1102) coupled with at least one memory (e.g., the memory 1104) and configured to cause the processor to receive a RRC resume request for a UE including a UE identifier and a CN identifier; transmit, to a CN function of the CN, a request for AS context information for the UE, the request including the UE identifier; receive, based at least in part on the request, an address of an AMF associated with the UE; and transmit, to the AMF, a request for AS information associated with the UE.

Additionally, the processor 1100 may be configured to or operable to support any one or combination of where the at least one processor is operable to cause the NE to receive: the AS context information associated with the UE; and security information including one or more of an AS key, a nonce, or a counter value; the security information is configured to be used to derive AS or NAS keys; the at least one processor is operable to cause the NE to: transmit a resume accept indication indicating that the RRC resume request of the UE is allowed.

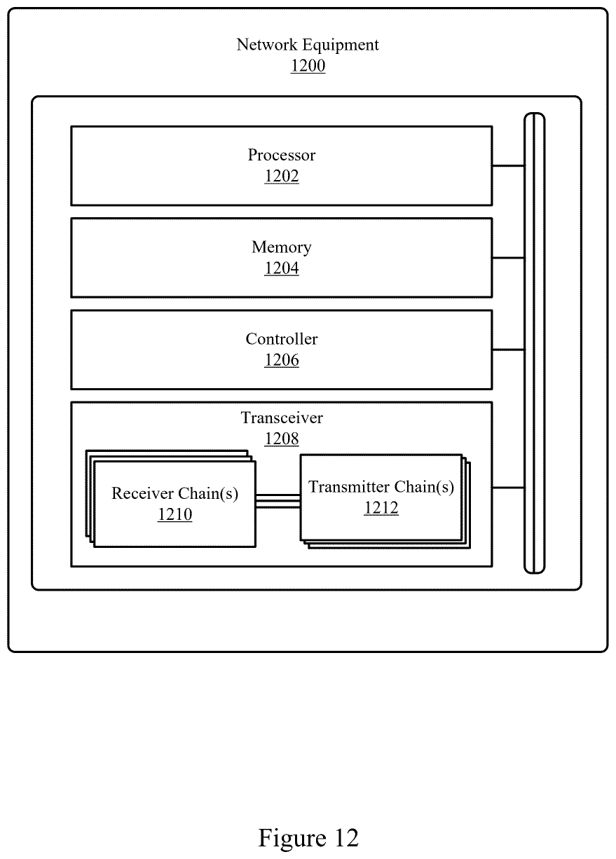

FIG. 12 illustrates an example of an NE 1200 in accordance with aspects of the present disclosure. The NE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the NE 1200 to perform various functions of the present disclosure.

The memory 1204 may include volatile or non-volatile memory. The memory 1204 may store computer-readable, computer-executable code including instructions when executed by the processor 1202 cause the NE 1200 to perform various functions described herein. The code may be stored in a non-transitory computer-readable medium such as the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the NE 1200 to perform one or more of the functions described herein (e.g., executing, by the processor 1202, instructions stored in the memory 1204). For example, the processor 1202 may support wireless communication at the NE 1200 in accordance with examples as disclosed herein.

The NE 1200 may be configured to or operable to support a means for receiving, from a first RAN node, an indication that a UE transitions to a RRC inactive state; receiving, from a CN entity, an indication of a CN area update for the UE, the indication of the CN area update based at least in part on a change in UE location and including at least one identifier for the CN entity; and transmitting AS context information for the UE to a second RAN node associated with the CN, the AS context information including SDT configuration including a DRB list permitted to transmit data in the RRC inactive state and a MAC PHY CG configuration.

Additionally, the NE 1200 may be configured to or operable to support any one or combination of storing one or more internet protocol (IP) addresses of one or more CN elements of the CN; storing one or more IP addresses of one or more RAN nodes associated with the CN; storing a mapping of the one or more IP addresses of the one or more CN elements to one or more other identities of the one or more CN elements; or storing a mapping of the one or more IP addresses of the one or more RAN nodes to one or more other identities of the one or more RAN nodes; maintaining a mapping between a UE identifier of the UE and an associated RAN context; updating the mapping based at least in part on a CN allocation, a CN update, or a CN change; registering with a NF as a trusted service for one or more CN functions of the CN; receiving an indication of an RRC release of the UE or a transition of the UE to an idle mode; and storing association data for an association between a UE identifier of the UE and the first RAN node; receiving an indication of deregistration of the UE from the RAN; and deleting a mapping of a UE identity of the UE to the RAN; receiving a query including a CN element identifier; and transmitting, based at least in part on the query, a response including an address for the CN element; receiving a query including a RAN node identifier; and transmitting, based at least in part on the query, a response including an address for the RAN node; receiving a query including an identifier for the UE; and transmitting, based at least in part on the query, a response including a UE identity for the UE; the UE identity is determined based at least in part on a mapping of the UE identifier to the RAN node; the NE is implemented as part of a NRF.

Additionally, or alternatively, the NE 1200 may support at least one memory (e.g., the memory 1204) and at least one processor (e.g., the processor 1202) coupled with the at least one memory and configured to cause the NE to receive, from a first RAN node, an indication that a UE transitions to a RRC inactive state; receive, from a CN entity, an indication of a CN area update for the UE, the indication of the CN area update based at least in part on a change in UE location and including at least one identifier for the CN entity; and transmit AS context information for the UE to a second RAN node associated with the CN, the AS context information including SDT configuration including a DRB list permitted to transmit data in the RRC inactive state and a MAC PHY CG configuration.

Additionally, the NE 1200 may be configured to support any one or combination of where the at least one processor is operable to cause the NE to one or more of: store one or more internet protocol (IP) addresses of one or more CN elements of the CN; store one or more IP addresses of one or more RAN nodes associated with the CN; store a mapping of the one or more IP addresses of the one or more CN elements to one or more other identities of the one or more CN elements; or store a mapping of the one or more IP addresses of the one or more RAN nodes to one or more other identities of the one or more RAN nodes; the at least one processor is operable to cause the NE to: maintain a mapping between a UE identifier of the UE and an associated RAN context; the at least one processor is operable to cause the NE to: update the mapping based at least in part on a CN allocation, a CN update, or a CN change; the at least one processor is operable to cause the NE to: register with a NF as a trusted service for one or more CN functions of the CN; the at least one processor is operable to cause the NE to: receive an indication of an RRC release of the UE or a transition of the UE to an idle mode; and store association data for an association between a UE identifier of the UE and the first RAN node; the at least one processor is operable to cause the NE to: receive an indication of deregistration of the UE from the RAN; and delete a mapping of a UE identity of the UE to the RAN; the at least one processor is operable to cause the NE to: receive a query including a CN element identifier; and transmit, based at least in part on the query, a response including an address for the CN element; the at least one processor is operable to cause the NE to: receive a query including a RAN node identifier; and transmit, based at least in part on the query, a response including an address for the RAN node; the at least one processor is operable to cause the NE to: receive a query including an identifier for the UE; and transmit, based at least in part on the query, a response including a UE identity for the UE; the UE identity is determined based at least in part on a mapping of the UE identifier to the RAN node; the NE is implemented as part of a NRF.

The NE 1200 may be configured to or operable to support a means for transmitting, to a UE and based at least in part on a RRC connection release for a UE, an RRC inactive configuration; and transmitting, to a serving AMF of the UE, the RRC inactive configuration.

Additionally, the NE 1200 may be configured to or operable to support any one or combination of where the RRC inactive configuration includes one or more of: AS context including a suspend configuration; or SDT configuration including DRB list permitted to transmit data in an RRC inactive state and a MAC PHY CG configuration.

Additionally, or alternatively, the NE 1200 may support at least one memory (e.g., the memory 1204) and at least one processor (e.g., the processor 1202) coupled with the at least one memory and configured to cause the NE to transmit, to a UE and based at least in part on a RRC connection release for a UE, an RRC inactive configuration; and transmit, to a serving AMF of the UE, the RRC inactive configuration.

Additionally, the NE 1200 may be configured to support any one or combination of where the RRC inactive configuration includes one or more of: AS context including a suspend configuration; or SDT configuration including DRB list permitted to transmit data in an RRC inactive state and a MAC PHY CG configuration.

The NE 1200 may be configured to or operable to support a means for receiving a RRC resume request for a UE including a UE identifier and a CN identifier; transmitting, to a CN function of the CN, a request for AS context information for the UE, the request including the UE identifier; receiving, based at least in part on the request, an address of an AMF associated with the UE; and transmitting, to the AMF, a request for AS information associated with the UE.

Additionally, the NE 1200 may be configured to or operable to support any one or combination of receiving the AS context information associated with the UE; and security information including one or more of an AS key, a nonce, or a counter value; the security information is configured to be used to derive AS or NAS keys; transmitting a resume accept indication indicating that the RRC resume request of the UE is allowed.

Additionally, or alternatively, the NE 1200 may support at least one memory (e.g., the memory 1204) and at least one processor (e.g., the processor 1202) coupled with the at least one memory and configured to cause the NE to receive a RRC resume request for a UE including a UE identifier and a CN identifier; transmit, to a CN function of the CN, a request for AS context information for the UE, the request including the UE identifier; receive, based at least in part on the request, an address of an AMF associated with the UE; and transmit, to the AMF, a request for AS information associated with the UE.

Additionally, the NE 1200 may be configured to support any one or combination of where the at least one processor is operable to cause the NE to receive: the AS context information associated with the UE; and security information including one or more of an AS key, a nonce, or a counter value; the security information is configured to be used to derive AS or NAS keys; the at least one processor is operable to cause the NE to: transmit a resume accept indication indicating that the RRC resume request of the UE is allowed.

The controller 1206 may manage input and output signals for the NE 1200. The controller 1206 may also manage peripherals not integrated into the NE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the NE 1200 may include at least one transceiver 1208. In some other implementations, the NE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas to receive a signal over the air or wireless medium. The receiver chain 1210 may include at least one amplifier (e.g., a low-noise amplifier (LNA)) configured to amplify the received signal. The receiver chain 1210 may include at least one demodulator configured to demodulate the receive signal and obtain the transmitted data by reversing the modulation technique applied during transmission of the signal. The receiver chain 1210 may include at least one decoder for decoding the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

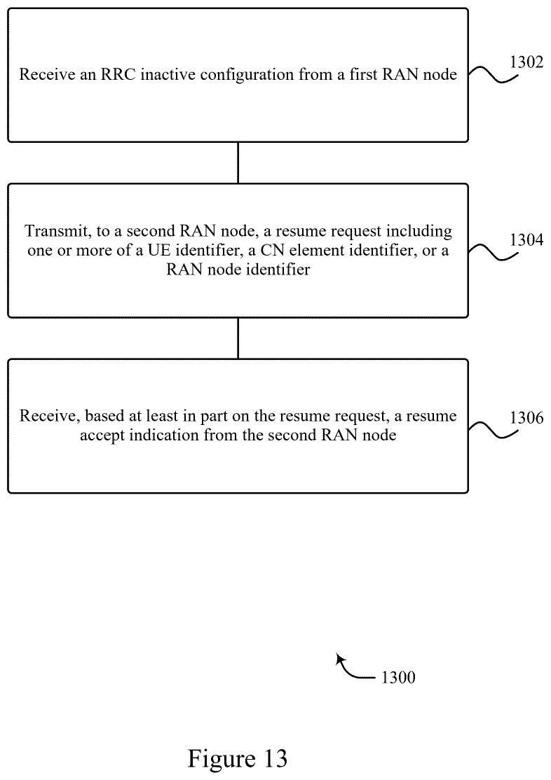

FIG. 13 illustrates a flowchart of a method 1300 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1302, the method may include receiving an RRC inactive configuration from a first RAN node. The operations of 1302 may be performed in accordance with examples as described herein. In some implementations, aspects of the operations of 1302 may be performed by a UE as described with reference to FIG. 10.

At 1304, the method may include transmitting, to a second RAN node, a resume request including one or more of a UE identifier, a CN element identifier, or a RAN node identifier. The operations of 1304 may be performed in accordance with examples as described herein. In some implementations, aspects of the operations of 1304 may be performed by a UE as described with reference to FIG. 10.

At 1306, the method may include receiving, based at least in part on the resume request, a resume accept indication from the second RAN node. The operations of 1306 may be performed in accordance with examples as described herein. In some implementations, aspects of the operations of 1306 may be performed a UE as described with reference to FIG. 10.

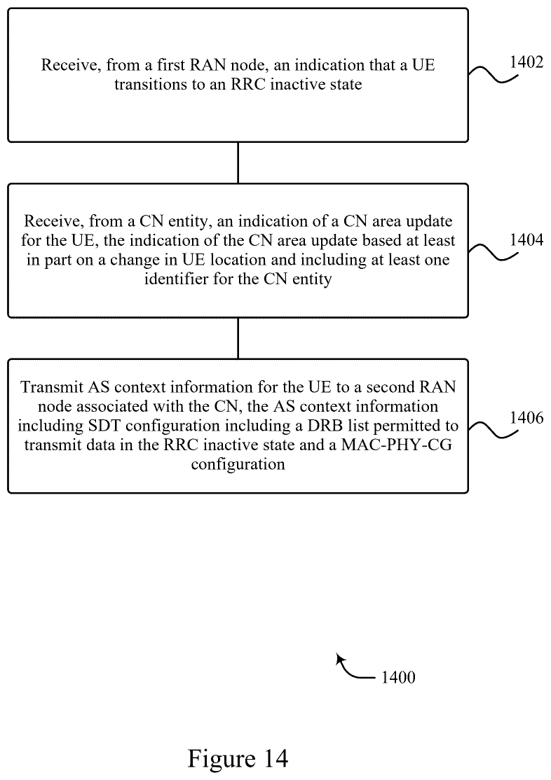

FIG. 14 illustrates a flowchart of a method 1400 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1402, the method may include receiving, from a first RAN node, an indication that a UE transitions to an RRC inactive state. The operations of 1402 may be performed in accordance with examples as described herein. In some implementations, aspects of the operations of 1402 may be performed by an NE as described with reference to FIG. 12.

At 1404, the method may include receiving, from a CN entity, an indication of a CN area update for the UE, the indication of the CN area update based at least in part on a change in UE location and including at least one identifier for the CN entity. The operations of 1404 may be performed in accordance with examples as described herein. In some implementations, aspects of the operations of 1404 may be performed by an NE as described with reference to FIG. 12.

At 1406, the method may include transmitting AS context information for the UE to a second RAN node associated with the CN, the AS context information including SDT configuration including a DRB list permitted to transmit data in the RRC inactive state and a MAC-PHY-CG configuration. The operations of 1406 may be performed in accordance with examples as described herein. In some implementations, aspects of the operations of 1406 may be performed an NE as described with reference to FIG. 12.

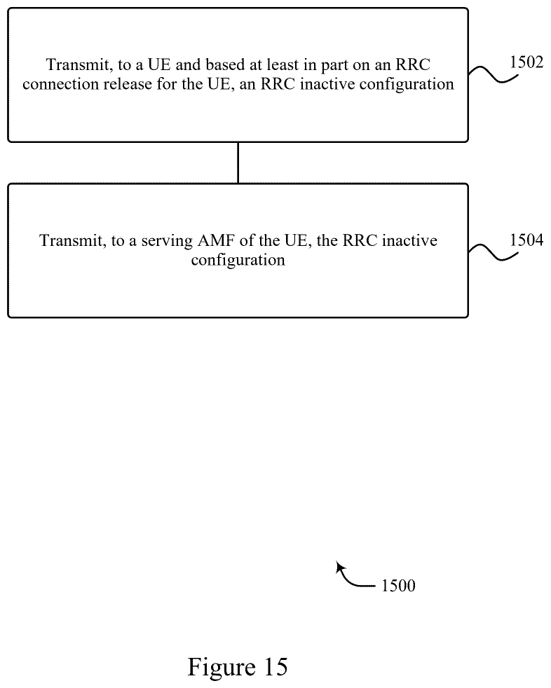

FIG. 15 illustrates a flowchart of a method 1500 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1502, the method may include transmitting, to a UE and based at least in part on an RRC connection release for the UE, an RRC inactive configuration. The operations of 1502 may be performed in accordance with examples as described herein. In some implementations, aspects of the operations of 1502 may be performed by an NE as described with reference to FIG. 12.

At 1504, the method may include transmitting, to a serving AMF of the UE, the RRC inactive configuration. The operations of 1504 may be performed in accordance with examples as described herein. In some implementations, aspects of the operations of 1504 may be performed by an NE as described with reference to FIG. 12.

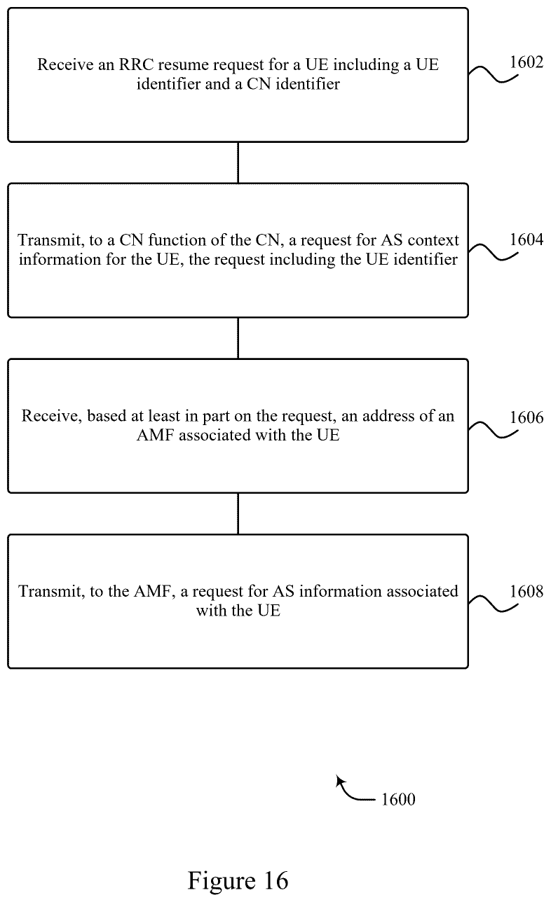

FIG. 16 illustrates a flowchart of a method 1600 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1602, the method may include receiving an RRC resume request for a UE including a UE identifier and a CN identifier. The operations of 1602 may be performed in accordance with examples as described herein. In some implementations, aspects of the operations of 1602 may be performed by an NE as described with reference to FIG. 12.

At 1604, the method may include transmitting, to a CN function of the CN, a request for AS context information for the UE, the request including the UE identifier. The operations of 1604 may be performed in accordance with examples as described herein. In some implementations, aspects of the operations of 1604 may be performed by an NE as described with reference to FIG. 12.

At 1606, the method may include receiving, based at least in part on the request, an address of an AMF associated with the UE. The operations of 1606 may be performed in accordance with examples as described herein. In some implementations, aspects of the operations of 1606 may be performed an NE as described with reference to FIG. 12.

At 1608, the method may include transmitting, to the AMF, a request for AS information associated with the UE. The operations of 1608 may be performed in accordance with examples as described herein. In some implementations, aspects of the operations of 1608 may be performed an NE as described with reference to FIG. 12.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network equipment (NE) for wireless communication, comprising:
at least one memory; and
at least one processor coupled with the at least one memory and operable to cause the NE to:
receive, from a first radio access network (RAN) node, an indication that a user equipment (UE) transitions to a radio resource control (RRC) inactive state;
receive, from a core network (CN) entity, an indication of a CN area update for the UE, the indication of the CN area update based at least in part on a change in UE location and comprising at least one identifier for the CN entity; and
transmit access stratum (AS) context information for the UE to a second RAN node associated with the CN, the AS context information comprising small data transmission (SDT) configuration including a data radio bearer (DRB) list permitted to transmit data in the RRC inactive state and a medium access control (MAC) physical (PHY) configured grant (CG) configuration.

2. The NE of claim 1, wherein the at least one processor is operable to cause the NE to one or more of:
store one or more internet protocol (IP) addresses of one or more CN elements of the CN;
store one or more IP addresses of one or more RAN nodes associated with the CN;
store a mapping of the one or more IP addresses of the one or more CN elements to one or more other identities of the one or more CN elements; or
store a mapping of the one or more IP addresses of the one or more RAN nodes to one or more other identities of the one or more RAN nodes.

3. The NE of claim 1, wherein the at least one processor is operable to cause the NE to:
maintain a mapping between a UE identifier of the UE and an associated RAN context.

4. The NE of claim 3, wherein the at least one processor is operable to cause the NE to:
update the mapping based at least in part on a CN allocation, a CN update, or a CN change.

5. The NE of claim 1, wherein the at least one processor is operable to cause the NE to:
register with a network function (NF) as a trusted service for one or more CN functions of the CN.

6. The NE of claim 1, wherein the at least one processor is operable to cause the NE to:
receive an indication of an RRC release of the UE or a transition of the UE to an idle mode; and
store association data for an association between a UE identifier of the UE and the first RAN node.

7. The NE of claim 1, wherein the at least one processor is operable to cause the NE to:
receive an indication of deregistration of the UE from the RAN; and
delete a mapping of a UE identity of the UE to the RAN.

8. The NE of claim 1, wherein the at least one processor is operable to cause the NE to:
receive a query comprising a CN element identifier; and
transmit, based at least in part on the query, a response comprising an address for the CN element.

9. The NE of claim 1, wherein the at least one processor is operable to cause the NE to:
receive a query comprising a RAN node identifier; and
transmit, based at least in part on the query, a response comprising an address for the RAN node.

10. The NE of claim 1, wherein the at least one processor is operable to cause the NE to:
receive a query comprising an identifier for the UE; and
transmit, based at least in part on the query, a response comprising a UE identity for the UE.

11. The NE of claim 10, wherein the UE identity is determined based at least in part on a mapping of the UE identifier to the RAN node.

12. The NE of claim 1, wherein the NE is implemented as part of a network repository function (NRF).

13. A network equipment (NE) for wireless communication, comprising:
at least one memory; and
at least one processor coupled with the at least one memory and operable to cause the NE to:
transmit, to a user equipment (UE) and based at least in part on a radio resource control (RRC) connection release for the user equipment (UE), an RRC inactive configuration; and
transmit, to a serving access and mobility management function (AMF) of the UE, the RRC inactive configuration.

14. The NE of claim 13, wherein the RRC inactive configuration comprises one or more of:
access stratum (AS) context comprising a suspend configuration; or
small data transmission (SDT) configuration comprising data radio bearer (DRB) list permitted to transmit data in an RRC inactive state and a medium access control (MAC) physical (PHY) configured grant (CG) configuration.

15. A network equipment (NE) for wireless communication, comprising:
at least one memory; and
at least one processor coupled with the at least one memory and operable to cause the NE to:
receive a radio resource control (RRC) resume request for a user equipment (UE) including a UE identifier and a core network (CN) identifier;
transmit, to a CN function of the CN, a request for access stratum (AS) context information for the UE, the request including the UE identifier;
receive, based at least in part on the request, an address of an access and mobility management function (AMF) associated with the UE; and
transmit, to the AMF, a request for AS information associated with the UE.

16. The NE of claim 15, wherein the at least one processor is operable to cause the NE to receive:
the AS context information associated with the UE; and
security information comprising one or more of an AS key, a nonce, or a counter value.

17. The NE of claim 16, wherein the security information is configured to be used to derive access stratum (AS) or non-AS (NAS) keys.

18. The NE of claim 15, wherein the at least one processor is operable to cause the NE to:
transmit a resume accept indication indicating that the RRC resume request of the UE is allowed.

19. A user equipment (UE) for wireless communication, comprising:
at least one memory; and
at least one processor coupled with the at least one memory and operable to cause the UE to:
receive a radio resource control (RRC) inactive configuration from a first radio access network (RAN) node;
transmit, to a second RAN node, a resume request comprising one or more of a UE identifier, a core network (CN) element identifier, or a RAN node identifier; and
receive, based at least in part on the resume request, a resume accept indication from the second RAN node.

20. The UE of claim 19, wherein the resume request is performed as part of a single area update procedure.
